(19) United States
(12) Patent Application Publication
(10) Pub. No.: US 2002/0046576 A1
(43) Pub. Date: Apr. 25, 2002

(54) Laminated glass panels

(76) Inventor: John Ross Campbell, Hamilton (CA)

Correspondence Address: ANTHONY ASQUITH, 173 WESTVALE DRIVE, WATERLOO, ON, N2T1B7, CA

(21) Appl. No.: 09/911,700

(22) Filed: Jul. 25, 2001

(30) Foreign Application Priority Data
Jul. 28, 2000 (CA) 2,314,763

(51) Int. Cl. C03B 33/03

(52) U.S. Cl. 65/56; 65/105; 65/174

(57) ABSTRACT

Decorative panels are manufactured by cutting out profiled shaped-pieces, using a numerically-controlled water-jet cutting machine. The shaped-pieces are picked from the cutting table by hand, and placed in the apertures of a pre-cut template, positioned on a base-pane. Colouring and texturing may be included. The base-pane, together with the shaped-pieces located thereon by the template, are placed in a furnace, and heated to fusing temperatures.

This invention relates to the production of decorative glass panels, in which the decoration takes the form of shaped glass pieces laminated upon, and adhering to, a base-pane of glass. Contributing to the decorative effect, the shaped-pieces may be coloured or textured.

### BACKGROUND TO THE INVENTION

The invention is concerned with panels in which cut-out shapes of glass are laminated to a base pane. Such panels are known in the prior art, in which the cut-out pieces are cut out by hand. The hand-cutting techniques include the traditional score-and-crack method, to produce a straight-line, or almost straight-line, break; and the traditional “nibbling” technique to produce curves. While it is not impossible to produce concave curves by nibbling, practically the process has been limited to convex curves.

Hitherto, the shaped-pieces have been cut out basically on a handicraft basis. That is to say, the pieces are cut by hand, and the quality of the cut is highly dependent upon the skill and care of the craftsperson doing the cutting. As a result, a good decorative panel, which includes several cut-out shaped-pieces, takes a long time to make; if the panels are used as (identical) door panels in a set of kitchen cabinets, for example, the set of panels can be very expensive.

Another difficulty is that the shaped-pieces had better be cut from the same piece of glass as the base-pane to which the shaped-pieces are to be adhered. The shaped-pieces are adhered to the base-pane by placing the base-pane, with the shaped-pieces laid thereupon, into a kiln or furnace. The heat causes the surface of the glass items to melt, and the pieces then fuse together. If the shaped-pieces have a different characteristic or coefficient of expansion/contraction, for example, from that of the base-pane, the decorative panel might be liable to crack as it cools. The traditional handicraft-system requires that the initial sheet of glass, i.e the sheet from which both the base-pane and the shaped-pieces are to be cut, must be quite large. Breakages will inevitably occur when making the shaped-pieces, especially if the pieces are elaborately or intricately shaped, and therefore a breakage allowance is needed.

With hand-cutting, the shaped-piece is not cut directly from the initial sheet. Rather, a small manageable section has to be cut from the large initial sheet, and then the detailed work is carried out on the small section. The small section is cut by score-and-crack, and score-and-crack cuts must extend right across, from edge to edge of the glass. Thus, even more allowance is needed, for cutting the small sections from which the final shaped-pieces will be cut. With the wastage and other allowances that must be made, clustering the shaped-pieces on the initial sheet for commercial economy can be difficult.

It is possible for batches of glass to be closely controlled, during manufacture, as to the uniformness of the characteristics of the glass, batch to batch, whereby the shaped-pieces need not be cut from the same initial sheet as the base-pane; but glass made to such all-the-same-properties standards is expensive.

Despite the difficulties and the expense, an artistically-designed coloured-glass panel can be very attractive indeed, and the effect of a set of them, e.g a set of, say, ten kitchen-cabinet doors, is stunning.

With the aim of simplifying the manufacture of the panels, some glass suppliers have offered the all-the-same-properties pieces on a pre-cut basis, done in artistic shapes such as flower petals etc. These pre-cut pieces have been supplied already coloured.

The invention is aimed at making it possible for decorative glass panels to be manufactured on a mass-production basis, rather than on a handicrafts basis, and especially to do so without resorting to (expensive) uniform-properties glass.

### GENERAL FEATURES OF THE INVENTION

The invention lies in a procedure for manufacturing decorative glass panels, of the kind having a base-pane, and having one or more shaped-pieces that lie flat upon, and are fused to, the base pane.

The glass panels are manufactured according to the following procedure.

The shaped-pieces are cut from an initial-sheet of glass in a numerically-controlled glass-cutting machine. The machine has the following operational characteristics: that a sheet of glass is placed in the path of a cutting-head, and the cutting-head is operable to cut right through the sheet of glass; that the arrangement of the machine is such that the cutting-head follows a profile laterally with respect to the sheet of glass; and the profile followed by the cutting-head relative to the sheet of glass is numerically programmable.

The invention also involves providing a template, having a plurality of apertures, the apertures respectively corresponding to the cut shapes of the shaped-pieces.

The shaped-pieces are removed from the cutting table of the cutting machine, and are placed in the apertures of the template.

When the shaped-pieces are in the positions and orientations on the base-pane as determined by the apertures of the template, the assembly is placed in a furnace.

Taking care to ensure that the shaped-pieces are not disturbed from their positions, the assembly of the base-pane and the shaped-pieces are heated together in the furnace, whereby the shaped-pieces become fused to the base-pane.

Finally, after cooling, the decorative panel comprising the base-pane with the shaped-pieces fused thereto, is removed from the furnace.

In the invention, preferably the shaped-pieces are laid in the apertures of the template manually; that is to say, by direct manipulation, with the hands and fingers, of a person.

Preferably, once the shaped-pieces have been cut, and the template has been prepared, the template is placed directly on the base-pane, and the template is fixed into a pre-determined position and orientation, in the lateral sense, relative to the base-pane, in such manner that the shaped-pieces, when placed in the apertures, rest directly upon the base-pane, and are held retained in position laterally with respect to the base-pane by the presence of the template.

### DETAILED DESCRIPTION OF PREFERRED EMBODIMENTS

By way of further explanation of the invention, exemplary embodiments of the invention will now be described with reference to the accompanying drawings, in which:

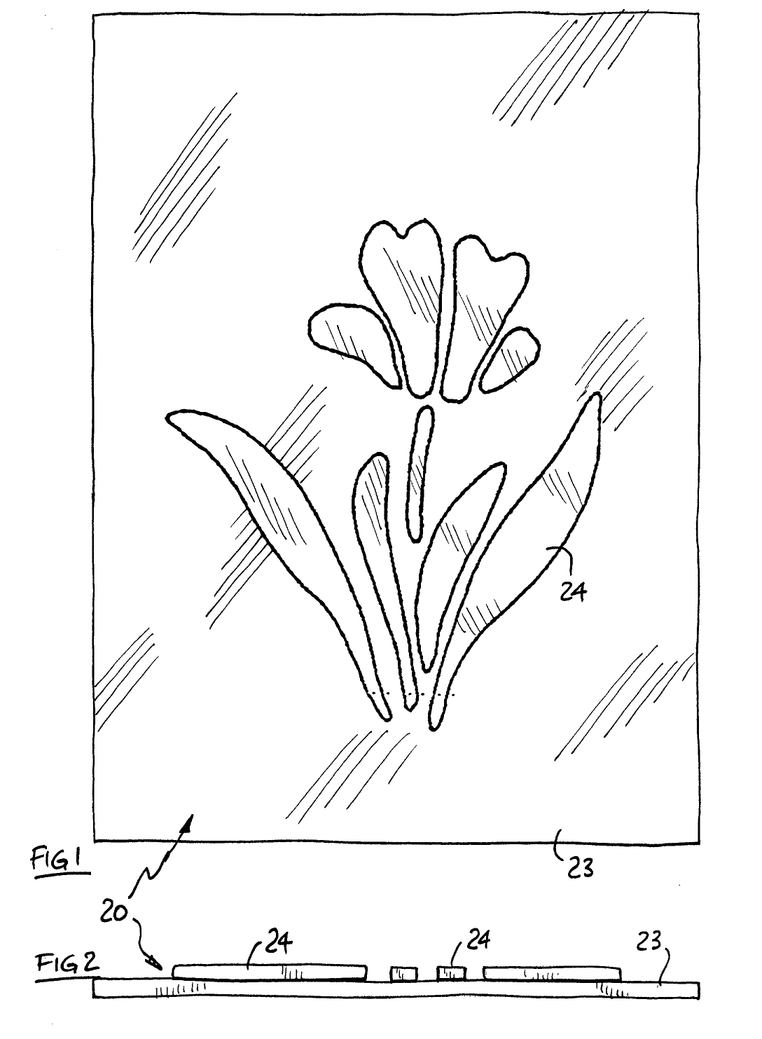

FIG. 1 is plan view of a decorative glass panel, in which a number of shaped-pieces have been laminated onto a base-pane in the manner of the invention.

FIG. 2 is a side edge view of the panel of FIG. 1.

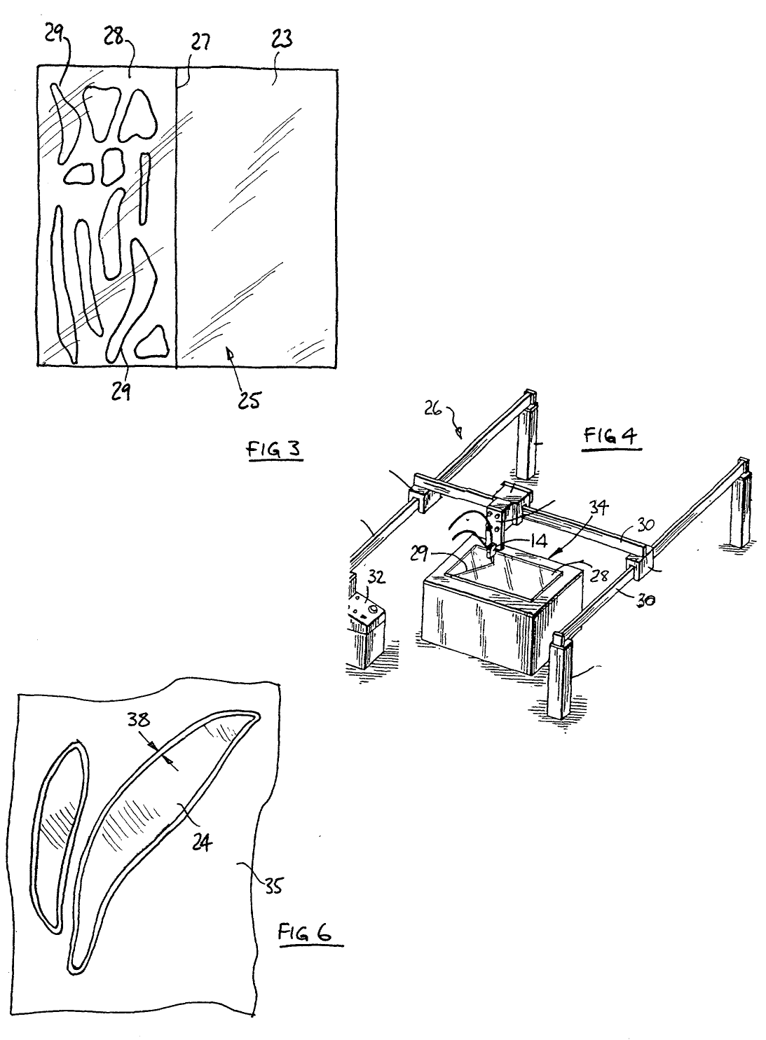

FIG. 3 is a plan-diagram of an initial-sheet of glass, showing a typical example of one of the pre-programmed profiled paths to be followed by the cutting head.

FIG. 4 is a pictorial diagram of a water-jet glass-cutting machine, in which a cutting-head can be traversed in a pre-programmed profiled path.

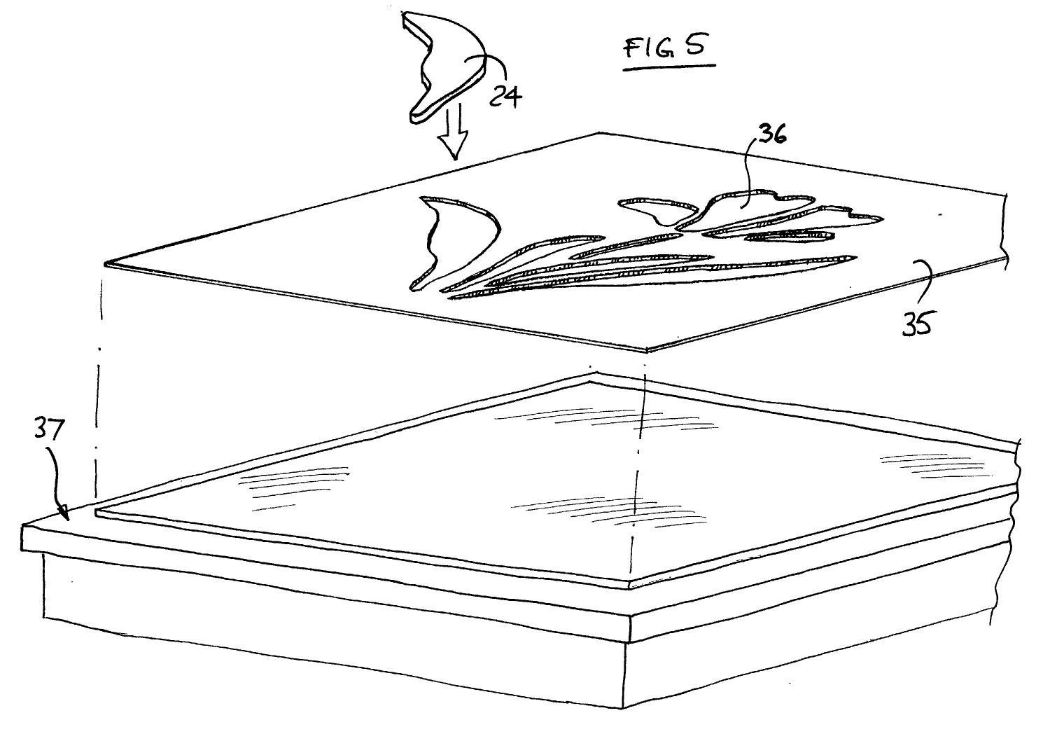

FIG. 5 is a pictorial diagram showing a base-pane, a positioning-template, and one of the shaped-pieces.

FIG. 6 is a plan-view of a template, having apertures in which are positioned some cut shaped-pieces.

The apparatuses shown in the accompanying drawings and described below are examples which embody the invention. It should be noted that the scope of the invention is defined by the accompanying claims, and not necessarily by specific features of exemplary embodiments.

As shown in FIGS. 1 and 2, the decorative glass panel 20 comprises a base-pane 23 and a number of shaped-pieces 24, which are laminated onto the base-pane, by being fused, in a kiln or furnace, onto the base-pane.

FIG. 3 shows an initial-sheet 25 of glass, from which both the base-pane 23 and the shaped-pieces 24 are to be cut. The shaped-pieces 24 are to be cut on a numerically-controlled (NC) water-jet glass-cutting machine 26 (FIG. 4). Such NC water-jet machines are well-known. The machines have been employed for cutting many materials, including glass.

The line 27, which separates the base-pane 23 from the portion 28 from which the pieces will be cut, may be cut by means of a conventional glass-cutter-plus-cracking technique, being a straight line, or the line 27 too may be cut with the water jet.

The portion 28 of the initial-sheet 25 is placed on the table. The markings 29 on the portion 28 are not actually marked on the glass, but rather the numeral 29 represents the profiles or paths the cutting-head 14 of the water-jet machine will make around the portion 28.

The cutting head is mounted on lead screws 30X,30Y, arranged as an orthogonal pair, and the machine includes a computer 32 whereby the lead screws can be set so as to position the cutting head at any point over the cutting table 34. The computer 32 can be programmed to make the cutting head follow the desired pre-determined pathway or profile 29. Once programmed, of course the pathway may be repeated, or recalled at any time in the future, with basically no loss of accuracy or repeatability.

In the water-jet process, the actual cutting of the glass is done by grains of abrasive dust, which are entrained in the water jet. The jet removes a thin slice of glass. The cut-edges of the shaped-pieces are left smooth and abraded, whereby the edges are not sharp or jagged, and there are no loose slivers or other hazards. The cut pieces can be picked up in the bare hands, with very little chance of accident. (But of course, the prudent operator would wear protective gloves anyway, if only to prevent finger-marking the shaped-pieces. Fingerprints that are invisible on the cold glass can become obtrusively visible in the final panel).

The pathway or profile 29 to be followed by the cutting-head can be simple or intricate, as determined by the programmer. The limitations as to what shapes can be done lie more in the area of ensuring that the shaped-pieces 24 are so shaped as to be chunky enough that the piece can be picked up and handled, rather than by limitations as to what shapes can actually be cut. (Traditionally, it has been the limitations of the cutting process itself that have restricted the shapes that can be cut.) With the water-jet machine, a shaped-piece would be too intricate and too fine, as to its shape, only if the shaped-piece is too fragile to be handled. The designer should have it in mind not to go too far in the direction of delicacy and intricacy of the shaped-pieces; although such pieces can be cut with the water-jet machine, and the pieces would survive the cutting process, the pieces might be too fragile to be handled.

It may be noted that, in the water-jet cutting machine, the glass does not need to be held down tightly while cutting proceeds. The water jet produces very little sideways component, so the shaped-piece has little tendency to be displaced laterally by the impact of the water jet.

After the water-jet cutting is complete, the cut shaped-pieces 24 now reside on the cutting-table 34 of the cutting-machine, each shaped-piece still in the as-cut positional relationship relative to the other shaped-pieces. The initial-sheet 25, or rather the portion 28 of the initial-sheet, remains as a matrix in which the several shaped-pieces remain located.

The several cut-out shaped-pieces 24 are now transferred from the cutting-table 34 of the water-jet cutting-machine, onto the base-pane 23. This aspect of the procedure is assisted by the use of a template.

FIG. 5 shows a template 35, having apertures 36. The template is used for locating the shaped-pieces 24 into their correct positions and orientations on the base-pane 23. The operator first places the base-pane 23 flat on a platform or table 37, and then places the template 35 over the base-pane.

Next, the operator aligns the template 35 to the base-pane 23. The alignment can be achieved by, for example, making the template to the same overall (rectangular) dimensions as the base-pane, whereby alignment consists simply of aligning the sides of the rectangles together. Or, the template may be brought into alignment by aligning the template to marks that have been made on the base-pane. Or, bearing in mind that the base-pane is made of transparent glass, marks can be drawn on the table 37 underneath the base-pane, and the operator aligns the template to the marks that s/he can see through the base-pane, having previously aligned the base-pane to other marks on the table 37. The base-pane 23 (or the template 35) may be sprayed with an adhesive, to make sure the template stays in place.

Alternatively, exact alignment of the template on the base-pane may be left until all the shaped-pieces have been placed in the respective apertures.

The apertures 36 in the template 35 have to be larger than the shaped-pieces 24. That is to say, a margin of clearance 38 (FIG. 6) must be present, in the respective aperture 36, all around the shaped-piece 24, to ensure that the shaped-piece can actually be inserted into its respective aperture in the template. It would not be acceptable for the apertures 36 to be cut size-on-size with the nominal outline of the shaped-pieces 24, because then the shaped-pieces would be too tight in the apertures, and there would be no margin for errors of cutting —i.e errors of cutting either the shaped-pieces or the apertures.

But because the shaped-pieces 24 have been cut so accurately, by the operation of the NC water-jet machine, the margin of clearance between the apertures 36 in the template 35 and the shaped-pieces need be only minimal. Cutting the apertures with a clearance margin of about 1 milli-metre, all around the respective shaped-pieces 24, may be expected to give all the clearance that might be needed. If the shaped-pieces 24 are small, and chunky in shape, the clearance margin may be even less than that.

Although the numerically-controlled pre-programmed water-jet cutting-machine 26 is very accurate and very repeatable, of course there is still some variation and error by which the cut-pieces 24 differ slightly from the programmed profile. The increased accuracy means the errors are made smaller, not that they are eliminated. The template apertures must be cut so that the margin of clearance 38 is large enough to allow for the worst accumulation of errors that might be present in any one of a production run of the shaped-pieces. A shaped-piece that will not fit its aperture, because its cutting errors are too much, will have to be rejected. The aperture should be cut with a large enough margin of clearance, with respect to the nominal profile of the shaped-piece, that none, or very few, of the cut shaped-pieces have to be rejected.

If the cutting process were not very accurate, and if the template apertures were cut with only a small margin of clearance, many or most of the cut shaped-pieces would have to be rejected. Either that, or the margin of clearance would have to be made larger. But the problem with making the margin of clearance larger is that now the pieces that are cut more closely to the nominal profile, or a little smaller, would start to become very loose in the template apertures, and not be located properly in position on the base-pane, by the fit of the shaped-piece in the aperture.

Thus there is a compromise: the margin of clearance should not be too small, whereby all but a few of the cut shaped-pieces have to be rejected; but the margin of clearance should not be too large, whereby the shaped-pieces that are cut exactly to the nominal profile, and smaller, are so loose in the apertures as to be not located properly.

It is recognised that this compromise between making the margin of clearance too small or too large is eased, the more accurately the shaped-pieces can be cut always to conform exactly to the nominal pre-programmed profile.

It is recognised that the traditional handicrafts techniques for cutting the shaped-pieces to a pre-determined profile were so inaccurate that the use of a template to locate the shaped-pieces in position on the base-pane would have been substantially pointless. The use of a template technique to locate hand-cut shaped-pieces on the base-pane, really would have involved making a fresh template for each panel. The craftsperson might as well make up the design by laying the pieces straight onto the base-pane—which is indeed how decorative panels have been manufactured, traditionally.

It is further recognised that, when the NC water-jet cutting technique is used to cut out the shaped-pieces, now the shaped-pieces conform so closely and repeatably to the nominal pre-determined profile, that the margin of clearance can be small. It is recognised that the margin of clearance can now be small enough that those shaped-pieces that happen to have no accumulated errors, or to have accumulated errors that make them smaller than the nominal profile, now are still close enough to the sides of the apertures as to still be well-located, by the apertures, as to position and orientation relative to the other shaped-pieces and to the base-pane.

It is recognised, in the invention, that the use of a template does not simplify matters when the shaped-pieces are cut by hand; but that a template will be highly useful for simplifying the task of locating the shaped-pieces in position on the base-pane, when the shaped-pieces are cut by NC machine.

Now that the shaped-pieces are cut to such close conformance to the nominal profile, the operator now does not have to select the pieces to fit the aperture. The operator can pick the cut shaped-piece, put it in the aperture, and move straight on to the next piece. The absence of the need to select and fit each shaped-piece means that the template technique is suitable for mass production of the decorative panels. The operator can be relatively unskilled, i.e s/he no longer need be an artist or a craftsperson. Measured in terms of the monetary cost of labour for manufacturing a set of identical decorative panels, the difference between the craft approach and the NC-cutting-plus-template approach is enormous.

It might be considered that it would be advantageous for the cut shaped-pieces to be picked from the cutting machine table, and placed on the base-pane, by an automatic pick-and-place apparatus. However, it is recognised that this would not be economical. Of course, automatic pick-and-place apparatus are well-known, in which a picking head is brought down into contact with a work-piece, and the work-piece is attached to the head, for example by means of vacuum suction. Then the head moves automatically, e.g under the control of a programmed computer, to a new location, where the piece is set down. In that case, there would be no need for templates, in that the shaped-pieces would be located in place by the programming of the pick-and-place apparatus. The use of a pick-and-place apparatus means there would be no need for an operator at all, to do the picking and placing.

This would be outside the present invention. The invention requires the combination of the accurate cutting of the profiles of the shaped-pieces (which results from NC cutting), and the use of an apertured template to assist the manual, i.e human, operation of then placing the cut shaped-pieces exactly at the desired position and orientation on the base-panel.

It is recognised, in the invention: (a) that templates do not contribute anything when the shaped-pieces are not cut accurately; and (b) that templates do not contribute anything when the shaped-pieces are picked and placed by automatic machine; but (c) that an appropriately-apertured template simplifies the manual task, by a human operator, of picking and placing the shaped-pieces, given that the shaped-pieces have been cut accurately by NC machine.

Some types of shapes of the shaped-pieces 24 tend to accumulate errors more than other shapes, during the water-jet cutting process. For example, the slight tendency of the water-jet process to deflect a cut piece laterally, small as that tendency is, is greater with a long thin shape than with a short chunky shape. The designer may therefore elect to provide a larger margin of clearance around some areas of the profile of the shaped-piece than around others, on the grounds that the errors are likely to be greater in those areas.

Also, the layout of the design itself may require more accuracy of placement in some areas than in others. In a design of a flower, for example, in which long thin petals or leaves radiate from a central core, it is probably more important that the radially-inner ends of the radiating pieces be more accurately positioned and aligned than the radially distant ends of those pieces. This difference in importance of alignment can be reflected in the difference in the size of the margin of clearance between the inner ends and the outer ends of the petal-pieces.

The apertures in the template preferably should be cut in a NC machine.

Generally, the shaped-pieces will not be aligned to the same position and orientation when placed on the base-pane as they were on the table of the water-jet glass-cutting machine. However, the profile of the shaped-piece, as an isolated profile, can be derived from the NC program used in the glass-cutting machine, and the program for that profile can serve as the basis for preparing the program for the profile of the respective aperture to be cut in the template. It is simple enough, with an NC cutting system, to program a margin of a certain width all around an already-programmed nominal shape.

Some shapes require a larger margin of clearance than other shapes. It is suggested that the margin of clearance, i.e the width of the margin between the nominal (i.e as-programmed) profile of the shaped-piece and the nominal profile of the aperture should be not less than about half a milli-metre wide if the shaped-piece is small and chunky, and not less than about one milli-metre if the shaped-piece is long and thin.

The clearance margin of a shaped-piece at a location where it is not so critical to the design may be left greater than the clearance margin around a shaped-piece of a similar size and shape, but which is more critically located.

Also, as mentioned, it is not a requirement that the margin of clearance be the same all around the shaped-piece.

Also, sometimes, if the designer wishes, the margin of clearance may be larger than is strictly needed from the standpoint of catering for errors in the cutting process. It is not difficult for an experienced programmer to modify the width of the margin, so the margin at one end of the piece is larger than the margin at the other end of the piece, if so desired (or allowed) by the designer of the decorative panel. The extra margin of clearance might be used to assist the operator in expending minimum time on the task of placing the shaped-piece in the aperture; but apart from that, there will usually be no point in allowing more margin than is needed to accommodate whatever (small) errors arise from the cutting process.

In some designs, the designer might elect to place two of the shaped-pieces in edge-to-edge abutment. In that case, the aperture in the template would be cut to accommodate the two shaped-pieces side by side. Of course, if the pieces are side by side, usually the designer will simply specify that the pieces are cut, not as two, but as one piece. However, sometimes, the designer might desire the extra line-definition that arises from actually separating the pieces. It is noted that cutting a template aperture to accommodate two shaped-pieces (or more than two) in edge-to-edge abutment, is hardly more difficult than cutting an aperture to accommodate just one shaped-piece.

As mentioned, it is not a requirement that the aperture margin be the same all around the shaped-piece. It is not a requirement that the wall of the aperture even be present, as a continuous wall, all around the shaped-piece. A shaped-piece can be perfectly well-located on the base-pane, even though the walls of the aperture abut the shaped-piece only over small, but strategically-placed, areas.

On the other hand, it is preferred that the aperture 36 should have a close visual resemblance to the shaped-piece 24 that is to fit therein, to make the task of placing the shaped-piece in the correct aperture a little easier.

The pieces to be laid together in one aperture need not have been cut together, in the same orientational and positional relationship on the table of the cutting machine as they have on the base-panel in the final design. For cutting, it can be arranged that the left side of one piece is cut by the same pass of the cutting head that cuts the right side of the adjacent piece. If the pieces share the same cut, then of course a convex curve on the piece to the left becomes a concave curve on the piece to the right; if the design permits or requires that, it can be done. Pieces cut like that may or may not be placed together in a single aperture of the template.

The shaped-pieces adhere to the base-pane, by fusing, when the glass pieces are brought to a temperature of around 1300 deg-F. Glass has the property, at this temperature, that the surfaces of the pieces fuse (i.e melt) just enough to run together, whereby the pieces, upon cooling, are integrated together.

It is not essential that the base-panel remain flat during firing of the assembled decorative panel. The panel may be placed on a dished mould (known as a sagger) and the heat is enough to cause the base-pane, together with the shaped-pieces resting thereon, to sag down into the mould.

The template may be secured in place on the base-pane with adhesive, and left in place during firing. Leaving the template in place ensures the shaped-pieces do not move during transfer of the base-pane and the assembled shaped-pieces from the assembly table onto the shelf of the furnace. The template (and the adhesive holding the template to the base-pane, if present) should be of a material that will combust, and will disappear completely, at the glass-fusing temperature. The template may be made of thin card (½mm), thick card, fibre-board, plywood, thin sheet plastic, thick polystyrene (10 mm), etc.

In the invention, it is preferred that the template be cut out by an NC cutting process—not necessarily the water-jet cutting apparatus, though that can be used. However, the NC-cutting of a template is much slower than, say, stamping the templates out. If the production run of a particular design warrants it, the designer might prefer to cut out a stamping tool, for stamping out large numbers of the same template, rather than cut out the individual templates.

It is not essential that the templates be destroyed. In a case where the template is to be re-used, the template may be made of metal. Generally, the economics of manufacturing small batches of decorative panels is such that the best economy comes from cutting the templates, in cardboard or polystyrene, one for each panel, by a pre-programmed NC cutter.

Colour is applied to decorative glass panels by applying the colouring materials between the base-pane and the shaped-pieces. During firing, as the pieces become fused to the base-pane, the colouring material is vitrified, and fixed into the panel. The colouring that is to show through the shaped-pieces may be applied as a flat area of colour, in the simplest form, or the colouring may be applied as an elaborate design in itself, and may include marked lines, differently-coloured areas, textures, and all the rest of the large variety of effects that can be achieved in decorative glass. The glass used for the decorative panels may be grained or textured, as manufactured, or may have some colouring already included, and the designer may blend the design into the as-manufactured characteristics of the glass.

The present invention is aimed at enabling the manufacture of the decorative panels to be (partially) automated, in the manner as described herein. Accordingly, it is preferred not to draw or paint a design onto the base-panel, or onto the shaped-pieces, on a crafts basis, but rather to pre-prepare the design in a reproducible manner, whereby the design can be applied to the base-pane by a relatively unskilled person.

To this end, the design may be pre-applied to a plastic transfer sheet, by a suitable batch printing process, from which the design is then transferred to the base-pane (or to the shaped-pieces). This is done before the shaped-pieces are located on the base-pane, and before the template is applied to the base-pane.

Special colouring-templates may be employed, in which spray colouring matter, frits, etc, may be applied, by spraying, pasting, sprinkling, brushing, etc, through the apertures in the colouring-templates. The apertures for the colouring matter should complement, but need not correspond to, the apertures in the template that hold the shaped-pieces in position.

The colouring materials may be applied by spraying or rolling the materials onto the shaped-pieces. The designer might prefer to arrange that batches of the shaped-pieces be coloured together, prior to being placed in the templates. A colouring station may be established, which is arranged for rapid application of colour, and for easy changeover between colours. For example, at the colouring station, the batch of pieces being worked on may be arranged on mesh, for example, so that the surplus colouring material drains away easily.

The invention may be applied even when the decorative design comprises just one single shaped-piece, to be laid on the base-pane. However, the invention is most advantageous when there are many shaped-pieces. Now, the need for a template which locates the shaped-pieces on the base-pane, accurately to a particular positional and orientational relationship to each other, becomes more acute. Basically, the more pieces, the greater the need for accuracy in their relative locations. When the shaped-pieces were cut by hand, if a template were used to position the pieces, the template would have to be five mm, or more, clear around the nominal profile of the shaped-piece. No designer could accept positioning accuracy like that.

The invention is aimed at bringing a degree of semi-automation to the process of manufacturing decorative glass panels. It is recognised that full automation, which would include automatic picking of the shaped-pieces, and automatic placing of same on the base-pane, is not appropriate for the type of small batch production which characterises the manufacture of decorative glass panels. It is recognised that the pick-and-place aspect of the manufacturing operation is best done manually—provided the operator has a template to simplify the task of placing the shaped-pieces on the base-pane. It is recognised that the template can only be useful if the shaped-pieces are cut very accurately, and it is recognised that they can be cut accurately enough on a NC cutting machine, and a water-jet machine is preferred because the cut pieces can be handled straight from the cutting machine.

Because much of the design is pre-prepared, and production involves simply reproducing the design, attention can be given to quality, both of the manufacturing itself, and of such operations as packaging (which is important in a glass product). Furthermore, the fact that the design is pre-programmed means that a broken panel can be replaced, even on a one-off basis. The design is simply called up again, from the computer, and the shaped-pieces, the templates, and the rest, can be remade.

The system of the invention is especially suited to small batches, but can be applied to larger production runs also. Thus, the system is highly suitable for decorative glass panels, where a designer wishes to offer a number of standard designs, as well as the facility for custom designs. With the invention, the only extra cost of the custom design lies in the time for the artist to make the design, and for the programmer to translate that to an NC program. Once that is done, the custom design passes through the production system exactly as does a standard design. Therefore, custom designs can be done to the same in-factory quality as standard designs, and are not hugely more expensive.

It is recognised that some types of automation are worth doing, others not. It is recognised that the automation system described herein allows an interaction between operator and automatic machine that is highly appropriate to the production of decorative glass panels. On the one hand, it would be difficult to amortize the cost of full automation, but on the other hand, the traditional not-at-all-automated crafts approach is very expensive, yet still quality can be poor. It is recognised, in the invention, that it is possible to move to a level of automation technology that can be amortized over the kinds of selling prices and quantities that will be made and sold, in the field of decorative glass panels.

The use of the invention also permits glass to be used more economically, in that hand cutting, even by a skilled craftsperson, gives far more breakages than a NC water-jet cutting machine. Therefore, also, it is possible to plan to make larger designs from a single sheet of glass.

The invention is also aimed at permitting savings on the inventory side. When the pieces were cut by hand, from the same sheet as each other and the base-pane, there was a problem of storing the cut pieces in such a way as to ensure retrieving and matching of the pieces from the same initial sheet. With the invention, there is hardly any need at all for work-in-progress inventory. The pieces are cut, placed on the base-pane, and inserted into the furnace, basically without any need for interim storage of the pieces between operations.

The invention is also aimed at making designs versatile as to fitment of the design onto differently-sized panels. For example, kitchen cabinet doors are not all the same width. Thus, the designer might wish to “fatten” a design that fits a door say 15 inches wide so as to fit doors 18″ and 21″ wide. It is an easy matter to have the computer increase all the left-right dimensions by a suitable factor. The factor can be applied to the shaped-pieces, the templates, etc, as required.

Generally, the NC water-jet cutting machine will be located in a different factory from the furnace. The table at which the panels are made up, prior to being placed in the furnace, should be located adjacent to the furnace, and arrangements made so that the assembled design of shaped-pieces resting on the base-pane can be transferred into the furnace without being disturbed. After cutting, the shaped-pieces should be removed from the table of the cutting machine, with appropriate precautions to prevent damage to the shaped-pieces; and also, given that the shaped-pieces will be moved, proper inventorying should be done of the shaped-pieces ready for transport and storage.

As mentioned, it would not be appropriate for the cut shaped-pieces to be picked individually from the cutting-table by automatic machinery. However, the cut shaped-pieces may be picked from the table of the cutting machine by, for example, pressing a sheet of plastic, card, or paper, etc, coated with a press-to-stick adhesive, over the cut pieces, and picking up the sheet, with the pieces adhering thereto, and this part of the process may be automated quite simply. It is the operation of picking and placing of the individual shaped-pieces into the apertures of the template that is much more difficult to automate, and that operation preferably should be done by hand, in the invention.

The designer may also prefer to use a backing sheet when positioning the shaped-pieces on the base-panel. In this variation, the template is used to locate the shaped-pieces into position on a backing sheet, rather than into position directly onto the base-pane. This might be preferred, for example, to enable a stock of pre-positioned shaped-pieces to be made up, and stored, for later application to the base-panes. To apply the pattern of shaped-pieces to the base-pane, the base-pane is coated with suitable adhesive, and placed on top of the pattern of shaped-pieces; the assembly is then turned over, and the backing sheet (and the template) removed. Of course, the more times the assembled pattern of shaped-pieces is handled, the more opportunities arise whereby the shaped-pieces might be displaced from their correct locations on the base-pane; the preference is, therefore, to assemble the patterns of shaped-pieces, using the templates, as described, directly upon the base-panes.

It is not a limitation of the invention that only one level of the cut shaped-pieces can be laid upon the base-pane. Rather than just placing shaped-pieces upon the base-pane, the designer may prefer to place shaped-pieces upon shaped-pieces, thus building up more thicknesses of glass. The decorative effect of multiple thicknesses can be quite striking, as the light catches the many edges of the pieces of glass; this is especially so in panels such as sun-catchers, which are intended to flash and sparkle with ever-changing patterns.

In another variation, a template-positioned pattern of shaped-pieces may be sandwiched between two base-panes.

One of the benefits of the system as described herein is that it enables the initial-sheet of glass to be used more efficiently, as to spacing of the shaped-pieces and the base-panel upon the initial sheet. Also, the fact that the glass is used more efficiently means that several more pieces can be cut from a single pane of glass, which can enable designs with many more intricate and complex shaped-pieces than has been possible hitherto.

However, although it is preferred that the shaped-pieces be cut from the same sheet as the base-pane, and as each other, that is not essential, provided the characteristics of the glass remain compatible. The designer might prefer to use pre-coloured glass for some of the shaped-pieces. Also, the designer might prefer to use glass of different thicknesses for the shaped-pieces, for example. It may be noted that thick glass can be cut by water-jet almost as easily as thin glass: whereas hand-cutting, in practice, is limited to thin glass. The production systems as described herein make it a relatively simple matter to produce decorative panels with different thicknesses of glass, thereby giving designers the ability to create varying raised-relief effects and light-catching edge-forms.

It should be noted that the glass used for the shaped-pieces, or for the base-panel, need not be clearly transparent, but may be translucent, or even opaque. The shaped-pieces are located into position on the base-pane by the template, and not be a person arranging the shaped-pieces by viewing a pattern placed underneath the base-pane, for example.

Although the invention has been described as it relates to the cutting of the shaped-pieces by water jet, other cutting technologies are available, for example laser cutting. The main requirements are that the edges as cut by the cutting head should be free of sharp edges and slivers; that the cutting technology does not impose forces on the pieces that could tend to cause them to shift during cutting, as that would spoil the accuracy and repeatability of the shaped pieces; and that the cutting machine is such that the profiled path followed by the cutting head is numerically-controlled, and can be pre-programmed.

1. Procedure for manufacturing decorative glass panels, wherein:
the panels comprise each a base-pane and shaped-pieces, and the shaped-pieces lie flat upon, and are fused to, the base pane;
the procedure includes:
cutting out the shaped-pieces from an initial-sheet of glass in a numerically-controlled glass-cutting machine;
the glass-cutting machine is a machine in which:
a sheet of glass is placed in the path of a cutting-head, and the cutting-head is operable to cut right through the sheet of glass;
in which the arrangement of the machine is such that the cutting-head follows a profile laterally with respect to the sheet of glass;
and the profile followed by the cutting-head relative to the sheet of glass is numerically programmable;
providing a template, having apertures, and the apertures correspond to the cut shapes of the shaped-pieces;
positioning the shaped-pieces on the base-bane, using the apertures in the template to locate the pieces in position thereon;
placing, in a furnace, the base-pane with the shaped-pieces resting thereon in the positions and orientations thereon as set by the apertures in the template;
ensuring that the shaped-pieces do not become disturbed, in the furnace, from their set positions and orientations on the base-pane;
heating the base-pane and the shaped-pieces together in the furnace, whereby the shaped-pieces become fused to the base-pane, and withdrawing the panel comprising the base-pane with the shaped-pieces fused thereto, after cooling, from the furnace.

2. Procedure of claim 1, wherein the cutting-head of the glass-cutting machine includes a water-jet, of such nature as to cut right through the sheet of glass.

3. Procedure of claim 1, wherein the apertures in the template are cut out on an NC machine.

4. Procedure of claim 3, wherein the procedure includes cutting the apertures in the template in a template cutting machine, in which the cutting-head follows a profile laterally with respect to the template, and the profile followed by the cutting-head relative to the template is numerically programmable.

5. Procedure of claim 1, including providing a coatings-template, placing the same over the base-pane; and applying colouring material onto the base-pane, through apertures in the coating-template.

6. Procedure of claim 1, wherein the operations of picking the shaped-pieces from the cutting machine, and placing the shaped-pieces in the apertures of the template on the base-pane, are carried out manually, by a human operator.

7. Procedure of claim 3, wherein, in respect of each aperture, the aperture is cut with a margin of clearance between the aperture and the respective shaped-piece placed in the aperture, whereby the shaped-piece is loose in the aperture, and the margin of clearance is small enough that no point on a shaped-piece cut exactly to the pre-programmed profile, and placed in the aperture, can be displaced laterally within the aperture a distance overall of no more than 3 mm.

8. Procedure of claim 7, wherein the shaped-piece is chunky in shape, and the shaped-piece can be displaced no more than 1 milli-metre.

9. Procedure of claim 1, wherein the procedure includes making the template from a combustible material, and keeping the template in place on the base-pane during firing, whereby the template is destroyed.

10. Apparatus of claim 1, wherein the procedure includes removing the template from the shaped-pieces and from the base-pane, prior to placing the base-pane and the shaped-pieces in the furnace.

11. Procedure of claim 1, wherein all the shaped-pieces and the base pane are cut from the same initial-sheet of glass.

12. Apparatus of claim 1, wherein the procedure includes:
placing the template directly upon the base-pane, in such manner that the shaped-pieces, placed in the apertures, can rest upon the base-pane, and be held retained in position laterally with respect to the base-pane by the presence of the template;
fixing the template into a pre-determined position and orientation, in the lateral sense, relative to the base-pane;
gathering the shaped-pieces, thus cut out on the cutting machine, and placing the shaped-pieces flat upon, and in direct contact with, the base-pane, placing and orientating the shaped-pieces into their respective apertures in the template.

12. Apparatus of claim 1, wherein the procedure includes:
placing the template on a backing-sheet, in such manner that the shaped-pieces, placed in the apertures, can rest upon the backing-sheet, and be held retained in position laterally with respect to the backing-sheet by the presence of the template;
fixing the template into a pre-determined position and orientation, in the lateral sense, relative to the backing-sheet;
gathering the shaped-pieces, thus cut out on the cutting machine, and placing the shaped-pieces flat upon the backing-sheet, placing and orientating the shaped-pieces into their respective apertures in the template;
and transferring the backing-sheet and the shaped-pieces positioned thereon, onto the base-pane.

13. Apparatus of claim 12, wherein the procedural step of gathering the shaped-pieces and placing the shaped-pieces flat upon the backing-sheet, and of placing and orientating the shaped-pieces into their respective apertures in the template, is carried out manually, by direct hand operation.
